(19) United States
(12) Patent Application Publication
(10) Pub. No.: US 2026/0270956 A1
(43) Pub. Date: Sep. 10, 2026

(54) APPARATUS, METHOD AND COMPUTER PROGRAM

(71) Applicant: Nokia Technologies Oy, Espoo (FI)

(72) Inventors: Sami-Jukka HAKOLA, Oulu (FI); Esa Tapani TIIROLA, Oulu (FI)

(21) Appl. No.: 19/163,299

(22) PCT Filed: Mar. 20, 2023
(86) PCT No.: PCT/EP2023/057079

§ 371 Date: Sep. 8, 2025

(51) Int. Cl. H04W 72/02; H04L 5/00; H04W 72/0457; H04W 72/12; H04W 72/51

(52) U.S. Cl. CPC H04W 72/02; H04L 5/0044; H04W 72/0457; H04W 72/12; H04W 72/51

(57) ABSTRACT

There is provided an apparatus comprising means for selecting, at a user equipment, a bandwidth portion from a first bandwidth portion and at least one second bandwidth portion, wherein the first bandwidth portion is smaller than the second bandwidth portion and is within an active bandwidth part of the user equipment and the second bandwidth portion is within or is equal to the active bandwidth part of the user equipment and means for receiving a physical downlink shared channel from a network at the user equipment using the selected bandwidth portion.

### FIELD

The present application relates to a method, apparatus, system and computer program and in particular but not exclusively to scheduling offset dependent receive bandwidth assumption in 6G.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is Universal Mobile Telecommunications System (UMTS) Terrestrial Radio Access Network (UTRAN) (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP). Other examples of communication systems include 5G-Advanced (NR Rel-18 and beyond) and 6G.

### SUMMARY

In a first aspect there is provided an apparatus comprising means for selecting at the user equipment a bandwidth portion from a first bandwidth portion and at least one second bandwidth portion, wherein the first bandwidth portion is smaller than the second bandwidth portion and is within an active bandwidth part of the user equipment and the second bandwidth portion is within or is equal to the active bandwidth part of the user equipment and means for receiving a physical downlink shared channel from a network at the user equipment using the selected bandwidth portion.

The apparatus may comprise means for receiving a scheduling offset value from the network at the user equipment and means for selecting the bandwidth portion from the first bandwidth portion and at least one second bandwidth portion based on the scheduling offset value.

The apparatus may comprise, if the scheduling offset value is less than a threshold value, means for selecting the first bandwidth portion and means for receiving the physical downlink shared channel from the network in the first bandwidth portion and if the scheduling offset value is greater than or equal to the threshold value, means for selecting the at least one second bandwidth portion and means for receiving the physical downlink shared channel from the network in the second bandwidth portion.

The threshold value may define at least one of the following: a number of slots, a number of symbols or a time period.

The apparatus may comprise means for providing an indication of a threshold value capability from the user equipment to the network.

The apparatus may comprise means for receiving an indication of the threshold value from the network at the user equipment, wherein the threshold value is greater than or equal to the threshold value capability.

The apparatus may comprise means for selecting the first bandwidth portion and means for receiving a control resource set in the first bandwidth portion.

The apparatus may comprise means for selecting the second bandwidth portion and means for receiving the physical downlink shared channel from the network in the second bandwidth portion, if one or more of the following conditions apply: back-to-back scheduling, back-to-back scheduling where reception bandwidth size does not increase or decrease in frequency from a previous scheduling, if a gap between the previous scheduling is smaller than T_{gap} or if the time gap between previous scheduling is smaller than T_{gap} and reception bandwidth size does not increase or decrease in frequency from the previous scheduling.

The size of the at least one second bandwidth portion may be equal to the size of the active bandwidth part of the user equipment.

The apparatus may comprise means for receiving an indication of the size of the first bandwidth portion from the network.

The indication of the size of the first bandwidth portion may further comprise an indication of the size of the active bandwidth part.

The size of the at least one second bandwidth portion may be less than the size of the active bandwidth part of the user equipment. The indication of the size of the first bandwidth portion may further comprise an indication of the size of the at least one second bandwidth portion.

In a second aspect there is provided an apparatus comprising means for selecting, at a network, a bandwidth portion from a first bandwidth portion and at least one second bandwidth portion, wherein the first bandwidth portion is smaller than the second bandwidth portion and is within an active bandwidth part of a user equipment and the second bandwidth portion is within the active bandwidth part of the user equipment and means for providing a physical downlink shared channel from the network to the user equipment using the selected bandwidth portion.

The apparatus may comprise means for providing a scheduling offset value from the network to the user equipment for use in selecting the bandwidth portion at the user equipment and means for selecting the bandwidth portion from the first bandwidth portion and at least one second bandwidth portion at the network based on the scheduling offset value.

The apparatus may comprise, if the scheduling offset value is less than a threshold value means for selecting the first bandwidth portion and if the scheduling offset value is greater than or equal to the threshold value, means for selecting the at least one second bandwidth portion.

The threshold value may define at least one of the following: a number of slots or a number of symbols.

The apparatus may comprise means for receiving an indication of a threshold value capability from the user equipment at the network.

The apparatus may comprise means for providing an indication of the threshold value from the network to the user equipment, wherein the threshold value indicated by the network is greater than or equal to the threshold value capability indicated by the user equipment.

The apparatus may comprise means for using the first bandwidth portion and means for providing a control resource set in the first bandwidth portion.

The apparatus may comprise means for selecting the second bandwidth portion and means for providing the physical downlink shared channel from the network to the user equipment in the second bandwidth portion, if one or more of the following conditions apply: back-to-back scheduling, back-to-back scheduling where reception bandwidth size does not increase or decrease in frequency from a previous scheduling, if a gap between the previous scheduling is smaller than T_{gap} or if the time gap between previous scheduling is smaller than T_{gap} and reception bandwidth size does not increase or decrease in frequency from the previous scheduling.

The size of the at least one second bandwidth portion may be equal to the size of the active bandwidth part of the user equipment.

The apparatus may comprise means for providing an indication of the size of the first bandwidth portion from the network to the user equipment.

The indication of the size of the first bandwidth portion may further comprise an indication of the size of the active bandwidth part.

The size of the at least one second bandwidth portion may be less than the size of the active bandwidth part of the user equipment. The indication of the size of the first bandwidth portion may further comprise an indication of the size of the at least one second bandwidth.

In a third aspect there is provided a method comprising selecting at the user equipment a bandwidth portion from a first bandwidth portion and at least one second bandwidth portion, wherein the first bandwidth portion is smaller than the second bandwidth portion and is within an active bandwidth part of the user equipment and the second bandwidth portion is within or is equal to the active bandwidth part of the user equipment and receiving a physical downlink shared channel from a network at the user equipment using the selected bandwidth portion.

The method may comprise receiving a scheduling offset value from the network at the user equipment and selecting the bandwidth portion from the first bandwidth portion and at least one second bandwidth portion based on the scheduling offset value.

The method may comprise, if the scheduling offset value is less than a threshold value, selecting the first bandwidth portion and receiving the physical downlink shared channel from the network in the first bandwidth portion and if the scheduling offset value is greater than or equal to the threshold value, selecting the at least one second bandwidth portion and receiving the physical downlink shared channel from the network in the second bandwidth portion.

The threshold value may define at least one of the following: a number of slots, a number of symbols or a time period.

The method may comprise providing an indication of a threshold value capability from the user equipment to the network.

The method may comprise receiving an indication of the threshold value from the network at the user equipment, wherein the threshold value is greater than or equal to the threshold value capability.

The method may comprise selecting the first bandwidth portion and receiving a control resource set in the first bandwidth portion.

The method may comprise selecting the second bandwidth portion and receiving the physical downlink shared channel from the network in the second bandwidth portion, if one or more of the following conditions apply: back-to-back scheduling, back-to-back scheduling where reception bandwidth size does not increase or decrease in frequency from a previous scheduling, if a gap between the previous scheduling is smaller than T_{gap} or if the time gap between previous scheduling is smaller than T_{gap} and reception bandwidth size does not increase or decrease in frequency from the previous scheduling.

The size of the at least one second bandwidth portion may be equal to the size of the active bandwidth part of the user equipment.

The method may comprise receiving an indication of the size of the first bandwidth portion from the network.

The indication of the size of the first bandwidth portion may further comprise an indication of the size of the active bandwidth part.

The size of the at least one second bandwidth portion may be less than the size of the active bandwidth part of the user equipment. The indication of the size of the first bandwidth portion may further comprise an indication of the size of the at least one second bandwidth portion.

In a fourth aspect there is provided a method comprising selecting, at a network, a bandwidth portion from a first bandwidth portion and at least one second bandwidth portion, wherein the first bandwidth portion is smaller than the second bandwidth portion and is within an active bandwidth part of a user equipment and the second bandwidth portion is within or is equal to the active bandwidth part of the user equipment and providing a physical downlink shared channel from the network to the user equipment using the selected bandwidth portion.

The method may comprise providing a scheduling offset value from the network to the user equipment for use in selecting the bandwidth portion at the user equipment and selecting the bandwidth portion from the first bandwidth portion and at least one second bandwidth portion at the network based on the scheduling offset value.

The method may comprise, if the scheduling offset value is less than a threshold value selecting the first bandwidth portion and if the scheduling offset value is greater than or equal to the threshold value, selecting the at least one second bandwidth portion.

The threshold value may define at least one of the following: a number of slots or a number of symbols.

The method may comprise receiving an indication of a threshold value capability from the user equipment at the network.

The method may comprise providing an indication of the threshold value from the network to the user equipment, wherein the threshold value indicated by the network is greater than or equal to the threshold value capability indicated by the user equipment.

The method may comprise using the first bandwidth portion and providing a control resource set in the first bandwidth portion.

The method may comprise selecting the second bandwidth portion and providing the physical downlink shared channel from the network to the user equipment in the second bandwidth portion, if one or more of the following conditions apply: back-to-back scheduling, back-to-back scheduling where reception bandwidth size does not increase or decrease in frequency from a previous scheduling, if a gap between the previous scheduling is smaller than T_{gap} or if the time gap between previous scheduling is smaller than T_{gap} and reception bandwidth size does not increase or decrease in frequency from the previous scheduling.

The size of the at least one second bandwidth portion may be equal to the size of the active bandwidth part of the user equipment.

The method may comprise providing an indication of the size of the first bandwidth portion from the network to the user equipment.

The indication of the size of the first bandwidth portion may further comprise an indication of the size of the active bandwidth part.

The size of the at least one second bandwidth portion may be less than the size of the active bandwidth part of the user equipment. The indication of the size of the first bandwidth portion may further comprise an indication of the size of the at least one second bandwidth.

In a fifth aspect there is provided an apparatus comprising at least one processor and at least one memory storing instructions that, when executed by the at least one processor, cause the apparatus at least to select at the user equipment a bandwidth portion from a first bandwidth portion and at least one second bandwidth portion, wherein the first bandwidth portion is smaller than the second bandwidth portion and is within an active bandwidth part of the user equipment and the second bandwidth portion is within or is equal to the active bandwidth part of the user equipment; and receive a physical downlink shared channel from a network at the user equipment using the selected bandwidth portion.

The apparatus may be caused to receive a scheduling offset value from the network at the user equipment and select the bandwidth portion from the first bandwidth portion and at least one second bandwidth portion based on the scheduling offset value.

The apparatus may be caused to, if the scheduling offset value is less than a threshold value, select the first bandwidth portion and receive the physical downlink shared channel from the network in the first bandwidth portion and if the scheduling offset value is greater than or equal to the threshold value, select the at least one second bandwidth portion and receive the physical downlink shared channel from the network in the second bandwidth portion.

The threshold value may define at least one of the following: a number of slots, a number of symbols or a time period.

The apparatus may be caused to provide an indication of a threshold value capability from the user equipment to the network.

The apparatus may be caused to receive an indication of the threshold value from the network at the user equipment, wherein the threshold value is greater than or equal to the threshold value capability.

The apparatus may be caused to select the first bandwidth portion and receive a control resource set in the first bandwidth portion.

The apparatus may be caused to select the second bandwidth portion and receive the physical downlink shared channel from the network in the second bandwidth portion, if one or more of the following conditions apply: back-to-back scheduling, back-to-back scheduling where reception bandwidth size does not increase or decrease in frequency from a previous scheduling, if a gap between the previous scheduling is smaller than T_{gap} or if the time gap between previous scheduling is smaller than T_{gap} and reception bandwidth size does not increase or decrease in frequency from the previous scheduling.

The size of the at least one second bandwidth portion may be equal to the size of the active bandwidth part of the user equipment.

The apparatus may be caused to receive an indication of the size of the first bandwidth portion from the network.

The indication of the size of the first bandwidth portion may further comprise an indication of the size of the active bandwidth part.

The size of the at least one second bandwidth portion may be less than the size of the active bandwidth part of the user equipment. The indication of the size of the first bandwidth portion may further comprise an indication of the size of the at least one second bandwidth portion.

In a sixth aspect there is provided an apparatus comprising at least one processor and at least one memory storing instructions that, when executed by the at least one processor, cause the apparatus at least to select, at a network, a bandwidth portion from a first bandwidth portion and at least one second bandwidth portion, wherein the first bandwidth portion is smaller than the second bandwidth portion and is within an active bandwidth part of a user equipment and the second bandwidth portion is within or is equal to the active bandwidth part of the user equipment and provide a physical downlink shared channel from the network to the user equipment using the selected bandwidth portion.

The apparatus may be caused to provide a scheduling offset value from the network to the user equipment for use in selecting the bandwidth portion at the user equipment and select the bandwidth portion from the first bandwidth portion and at least one second bandwidth portion at the network based on the scheduling offset value.

The apparatus may be caused to, if the scheduling offset value is less than a threshold value select the first bandwidth portion and if the scheduling offset value is greater than or equal to the threshold value, select the at least one second bandwidth portion.

The threshold value may define at least one of the following: a number of slots or a number of symbols.

The apparatus may be caused to receive an indication of a threshold value capability from the user equipment at the network.

The apparatus may be caused to provide an indication of the threshold value from the network to the user equipment, wherein the threshold value indicated by the network is greater than or equal to the threshold value capability indicated by the user equipment.

The apparatus may be caused to use the first bandwidth portion and provide a control resource set in the first bandwidth portion.

The apparatus may be caused to select the second bandwidth portion and provide the physical downlink shared channel from the network to the user equipment in the second bandwidth portion, if one or more of the following conditions apply: back-to-back scheduling, back-to-back scheduling where reception bandwidth size does not increase or decrease in frequency from a previous scheduling, if a gap between the previous scheduling is smaller than T_{gap} or if the time gap between previous scheduling is smaller than T_{gap} and reception bandwidth size does not increase or decrease in frequency from the previous scheduling.

The size of the at least one second bandwidth portion may be equal to the size of the active bandwidth part of the user equipment.

The apparatus may be caused to provide an indication of the size of the first bandwidth portion from the network to the user equipment.

The indication of the size of the first bandwidth portion may further comprise an indication of the size of the active bandwidth part.

The size of the at least one second bandwidth portion may be less than the size of the active bandwidth part of the user equipment. The indication of the size of the first bandwidth portion may further comprise an indication of the size of the at least one second bandwidth.

In a seventh aspect there is provided a computer readable medium comprising instructions which, when executed by an apparatus for a network node, cause the apparatus to perform at least the following: selecting, at a user equipment, a bandwidth portion from a first bandwidth portion and at least one second bandwidth portion, wherein the first bandwidth portion is smaller than the second bandwidth portion and is within an active bandwidth part of the user equipment and the second bandwidth portion is within or is equal to the active bandwidth part of the user equipment and receiving a physical downlink shared channel from a network at the user equipment using the selected bandwidth portion.

The apparatus may be caused to perform receiving a scheduling offset value from the network at the user equipment and selecting the bandwidth portion from the first bandwidth portion and at least one second bandwidth portion based on the scheduling offset value.

The apparatus may be caused to perform, if the scheduling offset value is less than a threshold value, selecting the first bandwidth portion and receiving the physical downlink shared channel from the network in the first bandwidth portion and if the scheduling offset value is greater than or equal to the threshold value, selecting the at least one second bandwidth portion and receiving the physical downlink shared channel from the network in the second bandwidth portion.

The threshold value may define at least one of the following: a number of slots, a number of symbols or a time period.

The apparatus may be caused to perform providing an indication of a threshold value capability from the user equipment to the network.

The apparatus may be caused to perform receiving an indication of the threshold value from the network at the user equipment, wherein the threshold value is greater than or equal to the threshold value capability.

The apparatus may be caused to perform selecting the first bandwidth portion and receiving a control resource set in the first bandwidth portion.

The apparatus may be caused to perform selecting the second bandwidth portion and receiving the physical downlink shared channel from the network in the second bandwidth portion, if one or more of the following conditions apply: back-to-back scheduling, back-to-back scheduling where reception bandwidth size does not increase or decrease in frequency from a previous scheduling, if a gap between the previous scheduling is smaller than T_{gap} or if the time gap between previous scheduling is smaller than T_{gap} and reception bandwidth size does not increase or decrease in frequency from the previous scheduling.

The size of the at least one second bandwidth portion may be equal to the size of the active bandwidth part of the user equipment.

The apparatus may be caused to perform receiving an indication of the size of the first bandwidth portion from the network.

The indication of the size of the first bandwidth portion may further comprise an indication of the size of the active bandwidth part.

The size of the at least one second bandwidth portion may be less than the size of the active bandwidth part of the user equipment. The indication of the size of the first bandwidth portion may further comprise an indication of the size of the at least one second bandwidth portion.

In an eighth aspect there is provided a computer readable medium comprising instructions which, when executed by an apparatus, cause the apparatus to perform at least the following: selecting, at a network, a bandwidth portion from a first bandwidth portion and at least one second bandwidth portion, wherein the first bandwidth portion is smaller than the second bandwidth portion and is within an active bandwidth part of a user equipment and the second bandwidth portion is within or is equal to the active bandwidth part of the user equipment and providing a physical downlink shared channel from the network to the user equipment using the selected bandwidth portion.

The apparatus may be caused to perform providing a scheduling offset value from the network to the user equipment for use in selecting the bandwidth portion at the user equipment and selecting the bandwidth portion from the first bandwidth portion and at least one second bandwidth portion at the network based on the scheduling offset value.

The apparatus may be caused to perform, if the scheduling offset value is less than a threshold value selecting the first bandwidth portion and if the scheduling offset value is greater than or equal to the threshold value, selecting the at least one second bandwidth portion.

The threshold value may define at least one of the following: a number of slots or a number of symbols.

The apparatus may be caused to perform receiving an indication of a threshold value capability from the user equipment at the network.

The apparatus may be caused to perform providing an indication of the threshold value from the network to the user equipment, wherein the threshold value indicated by the network is greater than or equal to the threshold value capability indicated by the user equipment.

The apparatus may be caused to perform using the first bandwidth portion and providing a control resource set in the first bandwidth portion.

The apparatus may be caused to perform selecting the second bandwidth portion and providing the physical downlink shared channel from the network to the user equipment in the second bandwidth portion, if one or more of the following conditions apply: back-to-back scheduling, back-to-back scheduling where reception bandwidth size does not increase or decrease in frequency from a previous scheduling, if a gap between the previous scheduling is smaller than T_{gap} or if the time gap between previous scheduling is smaller than T_{gap} and reception bandwidth size does not increase or decrease in frequency from the previous scheduling.

The size of the at least one second bandwidth portion may be equal to the size of the active bandwidth part of the user equipment.

The apparatus may be caused to perform providing an indication of the size of the first bandwidth portion from the network to the user equipment.

The indication of the size of the first bandwidth portion may further comprise an indication of the size of the active bandwidth part.

The size of the at least one second bandwidth portion may be less than the size of the active bandwidth part of the user equipment. The indication of the size of the first bandwidth portion may further comprise an indication of the size of the at least one second bandwidth.

In a ninth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a schematic diagram of bandwidth parts in a carrier bandwidth;

FIG. 5 shows a flowchart of a procedure for generating PDCCH from DCI;

FIG. 6a shows a block diagram of time domain slots;

FIG. 6b shows a block diagram of time domain slots;

FIG. 7 shows a flowchart of a method according to an example embodiment;

FIG. 8 shows a flowchart of a method according to an example embodiment;

FIG. 9 shows a block diagram of slots in the time domain against frequency;

FIG. 10 shows a signalling flow between a UE and a gNB according to an example embodiment.

### DETAILED DESCRIPTION

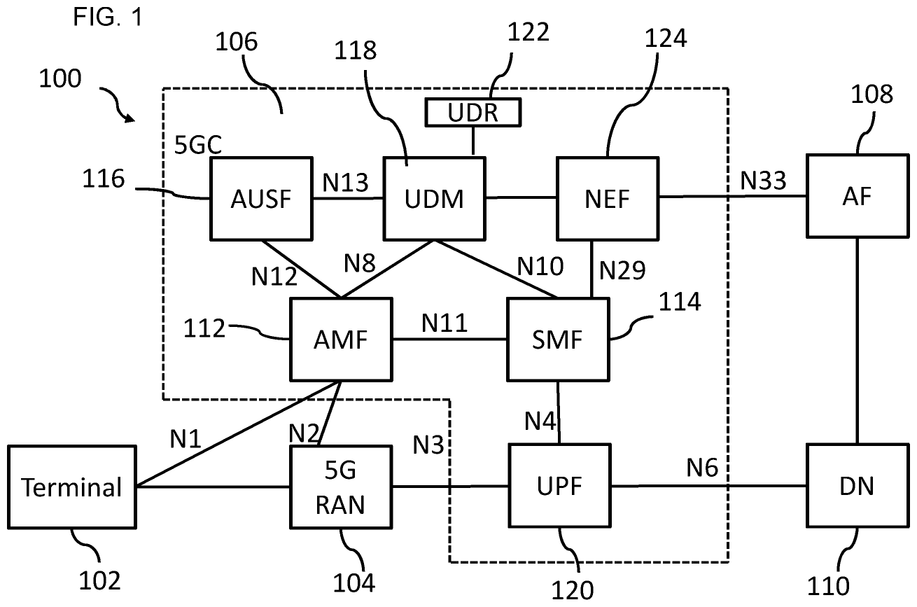

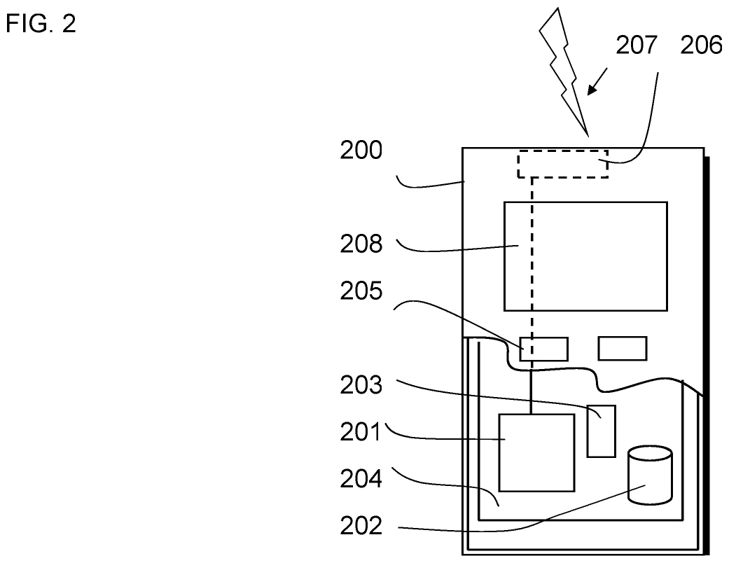

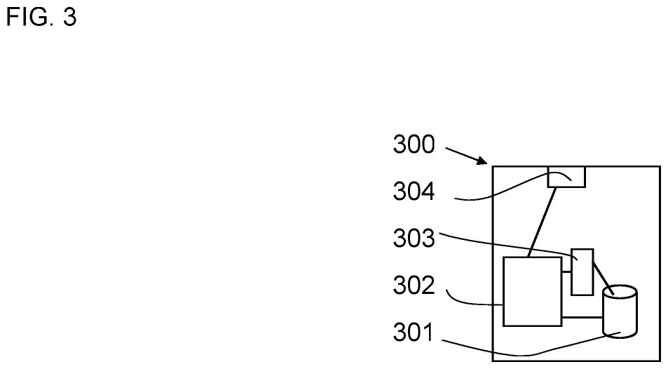

Before explaining in detail the examples, certain general principles of a wireless communication system and mobile communication devices are briefly explained with reference to FIG. 1, FIG. 2 and FIG. 3 to assist in understanding the technology underlying the described examples.

An example of a suitable communications system is the 5G or NR concept. Network architecture in NR may be similar to that of LTE-advanced. Base stations of NR systems may be known as next generation NodeBs (gNBs). Changes to the network architecture may depend on the need to support various radio technologies and finer Quality of Service (QoS) support, and some on-demand requirements for e.g. QoS levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use Multiple Input-Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more internal or external application functions (AF) 108 and one or more data networks (DN) 110.

An example 5G core network (CN) comprises functional entities. The 5GCN 106 may comprise one or more Access and mobility Management Functions (AMF) 112, one or more session management functions (SMF) 114, an authentication server function (AUSF) 116, a Unified Data Management (UDM) 118, one or more user plane functions (UPF) 120, a Unified Data Repository (UDR) 122 and/or a Network Exposure Function (NEF) 124. The UPF is controlled by the SMF (Session Management Function) that receives policies from a PCF (Policy Control Function).

The CN is connected to a UE via the Radio Access Network (RAN). The 5GRAN may comprise one or more gNodeB (gNB) Distributed Unit (DU) functions connected to one or more gNodeB (gNB) Centralized Unit (CU) functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VoIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts, and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

FIG. 3 shows an example of a control apparatus 300 for a communication system, for example to be coupled to and/or for controlling a station of an access system, such as a RAN node, e.g. a base station, eNB or gNB, a relay node or a core network node such as an MME or Serving Gateway (S-GW) or Packet Data Network Gateway (P-GW), or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller.

The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

Methods to enhance UE's frequency domain operation are provided. In 5G the concept of bandwidth part (BWP) has been adopted. According to 3GPP standards, a carrier bandwidth part is defined as a contiguous set of physical resource blocks, selected from a contiguous subset of the common resource blocks for a given numerology (μ) on a given carrier.

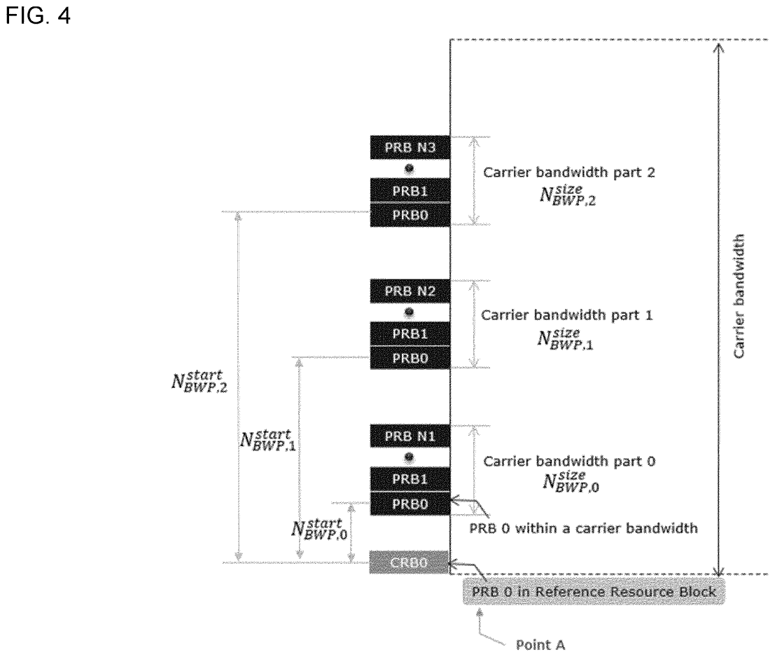

FIG. 4 shows an illustration of three carrier BWPs (BWP,0; BWP,1 and BWP,2) in a carrier bandwidth. CRB in this illustration stands for Common Resource Block which is numbered from one end through the other end of the Carrier Bandwidth. CRB is an example of a global resource block. The PRB stands for Physical Resource Block, which are the resource blocks numbered within each BWP.

Point A in FIG. 4 indicates a common reference point for resource block grids and is obtained from the following higher-layer parameters as described in 3GPP standards.

PRB-index-DL-common for a Primary Cell (PCell) downlink represents the frequency offset between point A and the lowest subcarrier of the lowest resource block of the SS/PBCH block used by the UE for initial cell selection.

PRB-index-UL-common for a PCell uplink in paired spectrum represents the frequency offset between point A and the frequency location based on ARFCN of the uplink indicated in SIB1.

PRB-index-UL-common for a PCell uplink in unpaired spectrum represents the frequency offset between point A and the lowest subcarrier of the lowest resource block of the SS/PBCH block used by the UE for initial cell selection.

PRB-index-DL-Dedicated for a Secondary Cell (SCell) downlink represents the frequency offset between point A and the frequency location based on Absolute Radio-Frequency Channel Number (ARFCN) in the higher-layer SCell configuration.

PRB-index-UL-Dedicated for an SCell uplink represents the frequency offset between point A and the frequency location based on ARFCN in the higher-layer SCell configuration.

PRB-index-SUL-common for a supplementary uplink represents the frequency offset between point A and the frequency location based on ARFCN in the higher-layer SUL configuration.

Although FIG. 4 shows three BWP, a maximum of four 4 BWP can be specified in downlink (DL) and uplink (UL). According to current specifications, only one BWP can be active at a time in DL and UL. In future, this restriction may be removed.

In DL, a UE can be configured with up to four carrier bandwidth parts. The bandwidth of each BW should be equal or greater than Synchronisation Signal (SS) Block BW, but it may or may not contain SS Block. Only one carrier bandwidth part can be active at a given time. The UE is not expected to receive Physical Downlink Shared Channel (PDSCH), Physical Downlink Control Channel (PDCCH), Channel State Information Reference Signals (CSI-RS), or Tracking Reference Signals (TRS) outside an active bandwidth part. Each DL BWP include at least one CORESET with UE Specific Search Space (USS). In primary carrier, at least one of the configured DL BWPs includes one CORESET with common search space (CSS).

In UL, a UE can be configured with up to four carrier bandwidth parts. Only one carrier bandwidth part can be active at a given time. If a UE is configured with a supplementary uplink, the UE can in addition be configured with up to four carrier bandwidth parts in the supplementary uplink and only one carrier bandwidth part can be active at a given time. The UE shall not transmit Physical Uplink Shared Channel (PUSCH) or Physical Uplink Control Channel (PUCCH) outside an active bandwidth part.

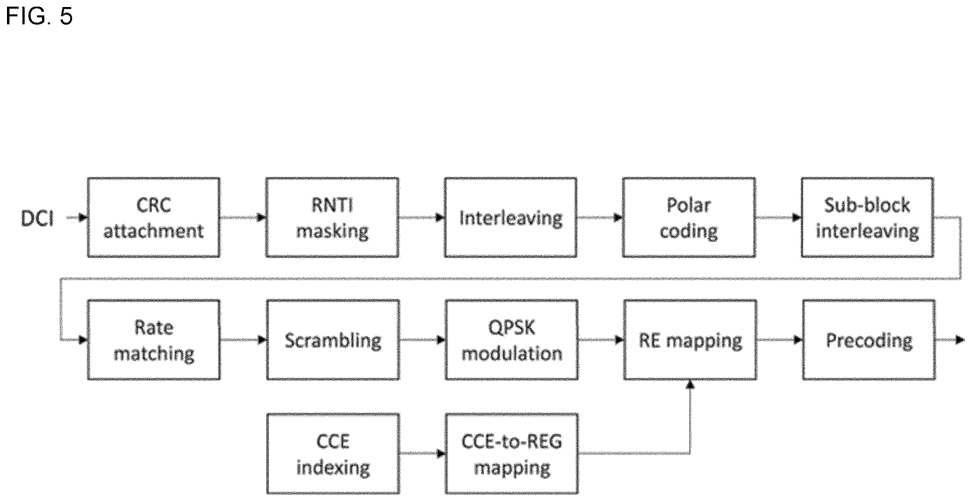

The procedure for generating a PDCCH in NR is illustrated in FIG. 5. If the size of the Downlink Control Information (DCI) format is less than 12 bits, a few zero padding bits will be appended until the payload size equals 12 bits. For the DCI payload bits, a 24-bit cyclic redundancy check (CRC) is calculated and appended to the payload. The CRC allows the UE to detect the presence of errors in the decoded DCI payload bits. After the CRC is attached, the last 16 CRC bits are masked with a corresponding identifier, referred to as a radio network temporary identifier (RNTI). Using the RNTI mask, the UE can detect the DCI for its unicast data and distinguish sets of DCI with different purposes that have the same payload size. The CRC attached bits are then interleaved to distribute the CRC bits among the information bits. The interleaver supports a maximum input size of 164 bits. This means that DCI without CRC can have at most 140 of payload bits. The bits are then encoded by the Polar encoder to protect the DCI against errors during transmission. The encoder output is processed using a sub-block interleaver and then rate matched to fit the allocated payload resource elements (REs) of the DCI.

The payload bits of each DCI are separately scrambled by a scrambling sequence generated from the length-31 Gold sequence. The scrambling sequence is initialized by the physical layer cell identity of the cell or by a UE specific scrambling identity and a UE specific cell RNTI (C-RNTI). After the scrambled DCI bit sequence is Quadrature Phase Shift Keying (QPSK) modulated, the complex-valued modulation symbols are mapped to physical resources in units referred to as control channel elements (CCEs). Each CCE consists of six resource element groups (REGs), where a REG is defined as one PRB in one orthogonal frequency-division multiplexing (OFDM) symbol which contains nine REs for the PDCCH payload and three demodulation reference signal (DMRS) REs. For each DCI, 1, 2, 4, 8, or 16 CCEs can be allocated, where the number of CCEs for a DCI is denoted as aggregation level (AL). With QPSK modulation, a CCE contains 54 payload REs and therefore can carry 108 bits. This requires the output size of the rate matching block to be L.108, where L is the associated AL. Based on the channel environment and available resources, the gNB can adaptively choose a proper AL for a DCI to adjust the code rate.

A DCI with AL L is mapped to physical resources in a given BWP, where necessary parameters such as frequency and time domain resources, and scrambling sequence identity for the DMRS for the PDCCH are configured to a UE by means of control resource set (CORESET). A UE may be configured with up to three CORESETs in Rel15 and up to five CORESETs in Rel16 (for multi-DCI multi-Transmission and Reception Point (TRP) operation) on each of up to four BWPs on a serving cell. In general, CORESETs are configured in units of six PRBs on a six PRB frequency grid and one, two, or three consecutive OFDM symbols in the time domain.

A DCI of AL L comprises L continuously numbered CCEs, and the CCEs are mapped on a number of REGs in a CORESET. NR supports distributed and localized resource allocation for a DCI in a CORESET. This is done by configuring interleaved or non-interleaved CCE-to-REG mapping for each CORESET. For interleaved CCE-to-REG mapping, REG bundles constituting the CCEs for a PDCCH are distributed in the frequency domain in units of REG bundles. A REG bundle is a set of indivisible resources consisting of neighboring REGs. A REG bundle spans across all OFDM symbols for the given CORESET. Once the REGs corresponding to a PDCCH are determined, the modulated symbols of the PDCCH are mapped to the REs of the determined REGs in the frequency domain first and the time domain second, i.e. in increasing order of the RE index and symbol index, respectively.

The UE performs blind decoding for a set of PDCCH candidates. PDCCH candidates to be monitored are configured for a UE by means of search space (SS) sets. There are two SS set types: common SS (CSS) set, which is commonly monitored by a group of UEs in the cell, and UE-specific SS (USS) set, which is monitored by an individual UE. A UE can be configured with up to 10 SS sets each for up to four BWPs in a serving cell. In general, SS set configuration provides a UE with the SS set type (CSS set or USS set), DCI format(s) to be monitored, monitoring occasion, and the number of PDCCH candidates for each AL in the SS set.

A SS set with index s is associated with only one CORESET with index p. The UE determines the slot for monitoring the SS set with index s based on the higher layer parameters for periodicity k, offset o, and duration d, where periodicity k and offset o provide a starting slot and duration d provides the number of consecutive slots where the SS set is monitored starting from the slot identified by k and o.

The mapping of PDCCH candidates of an SS set to CCEs of the associated CORESET is implemented by means of a hash function. The hash function randomizes the allocation of the PDCCH candidates within CORESET.

Three ‘k’ values govern time domain slot & symbol level resource allocation in 5G NR, based on 3GPP standards.

k0 is the offset between the DL slot where the PDCCH (DCI) for downlink scheduling is received and the DL Slot where PDSCH data is scheduled. k1 is the offset between the DL slot where the data is scheduled on PDSCH and the UL slot where the ACK/NACK Feedback for the scheduled PDSCH data need to be sent. k2 Is the offset between the DL slot where the PDCCH (DCI) for Uplink scheduling is received and the UL Slot where the UL data need to be sent on PUSCH.

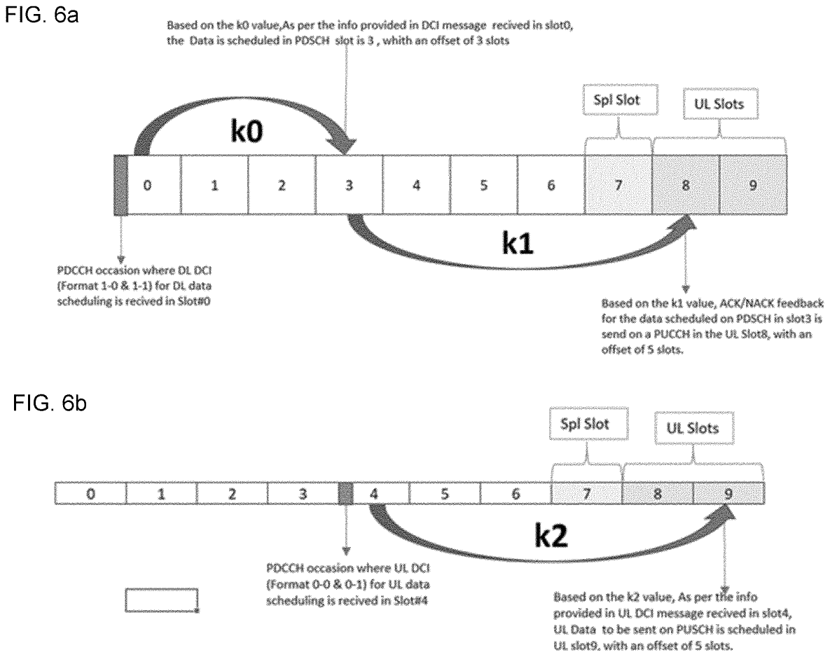

FIGS. 6a and 6b illustrate how a UE interprets each of these ‘k’ values when gNB allocates Time Domain resources per UE.

FIG. 6a shows a PDCCH occasion where DL DCI (Format 1-0 and 1-1) for DL data scheduling is received in Slot #0. Based on the k0 value, as per the information received in slot #0, the data is scheduled on PDSCH in slot #3, with an offset of 3 slots. Based on the k1 value, ACK/NACK feedback for the data scheduled on PDSCH in slot #3 is sent on a PUCCH in the UL slot #8 with an offset of 5 slots.

In FIG. 6b, the PDCCH occasion where UL DCI (Format 0-0 and 0-1) for UL data scheduling is received in slot #4. Based on the k2 value, as per the information provided in the UL DCI message received in slot #4, UL data to be sent on PUSCH is scheduling UL slot #9 with an offset of 5 slots.

In NR, DCI formats 1_0 and 1_1 are used to dynamically allocate time-domain resources for PDSCH. In the case of dynamic scheduling, PDCCH carrying DCI 1_0 and 1_1 are in general addressed to either C-RNTI or SPS-C-RNTI. DCI formats 1_0 and 1_1 carries 4-bit field named ‘time domain resource assignment’. There can be up to 16 rows in the look-up table or ‘pdsch-TimeDomainAllocationList’ and hence maximum 4-bits are used for the field ‘time domain resource assignment’ in a DCI message. When scheduling in a common search space for a SI-RNTI, RA-RNTI or P-RNTI, the ‘time domain resource assignment’ value points to one of the rows of a default look-up table (A, B or C) or ‘pdsch-TimeDomainAllocationList’ if provided in the Pdsch-ConfingCommon setup. When scheduling for C-RNTI in a UE Specific Search Space, the ‘time domain resource assignment’ value points to one of the rows in the ‘pdsch-TimeDomainAllocationList provided in the RRC Reconfig message under ‘pdsch-Config setup’.

Each row in the look-up table provides the following parameters as shown in Table 1.

TABLE 1

| Parameter | Funtionality |
|---|---|
| K0 | It is the slot offset from the slot where DCI is received |
| S | First symbol in the slot in which PDSCH will be received |
| L | Nnumber of consecutive symbols allocated for PDSCH. |
| PDSCH | PDSCH mapping type (Type A or Type B) to be assumed in |
| mapping | the PDSCH |
| type | |

When determining DL Slot & symbols for PDSCH data scheduling, PDCCH & PDSCH numerology (SCS) are not always the same, therefore determining slot offset for PDSCH allocation based only on k0 is not sufficient. The below equation may be used to determine the Slot Offset for PDSCH allocation.

The slot allocated for the PDSCH is

$$⌊ n \cdot \frac{{2}^{μ P D S C H}}{{2}^{μ P D D C H}} ⌋ + {K}_{0} ,$$

where n is the slot with the scheduling DCI.

PDCCH and PDSCH may have different numerology then as shown above scaling factor need to be added to k0 value, meaning if PDCCH DCI is scheduled in Slot1 and PDCCH SCS is 30 kHz (μ=2) and PDSCH is 120 Hz (μ=3) then the scaling factor is [1*2\hat{ }3/2\hat{ }2]=8/2=4 need to add this scaling factor to k0.

The following relates to 3GPP 6G physical layer design targeting the first release of 6G. For example, the following focuses on enabling energy efficient downlink data channel scheduling for a UE receiver. Energy efficiency is a consideration for 6G and may be one of the design principles for the physical layer design. In other words, energy efficiency may have a role when defining and deciding, for example, downlink (DL) and uplink (UL) waveform(s) and physical layer procedures such as but not limited to scheduling, dynamic frequency and time domain operation adaptation, etc.

In 6G wider bandwidths than in NR are considered. For example, 400 MHz bandwidth could be introduced to FR1 (Frequency Range 1 means carrier frequencies up 7 GHZ). Another scenario for 400 MHz bandwidth is a frequency band (/range) between 7 and 20 GHz. That would mean that when the UE is in connected mode and about to be scheduled downlink data the UE may be configured a BWP with up to 400 MHz bandwidth. Due to the fact that there is typically an assumption that the UE can perform PDCCH (transmitted in the beginning of the slot) blind detection operations within one slot, the UE needs to buffer all the time samples having the bandwidth of the BWP, in this example bandwidth of 400 MHz. 400 MHz bandwidth may require much larger FTT than in NR and it's likely that such big FTT is implemented using number of smaller FFTs (in size). Table 2 illustrates how many FFTs of size of 4096 (implementable in devices) is needed to be aggregated to achieve 100, 200 or 400 MHz bandwidth with different subcarrier spacings. Another option is to define a larger FFT, for example with size of 8192 (=2×4096) or 16834 (=4×4096). Buffering all the samples all the time in each slot within the full bandwidth of the BWP consumes significant amounts of power (UE needs to have for instance 4 FFTs running with 30 kHz sub-carrier spacing (SCS) when having 400 MHz BWP).

TABLE 2
How many FFTs of size of 4096

| | Bandwidth [MHz] | | |
|---|---|---|---|
| SCS [kHz] | 100 | 200 | 400 |
| 15 | 2 | 4 | 8 |
| 30 | 1 | 2 | 4 |
| 60 | 1 | 1 | 2 |

A UE can be configured with multiple BWPs of which one can be active. Active BWP can be switched either via RRC signaling (mandatory in NR for the UEs) or via DCI (optional in NR and not in use). It may not be feasible to use BWP switching frequently. BWP switching thus incurs additional network signalling and may increase adaptation latency.

Hence, for future networks may be useful to reduce latency when switching between reception bandwidth options as well as the signalling burden. The reduction of UE power consumption is also a consideration.

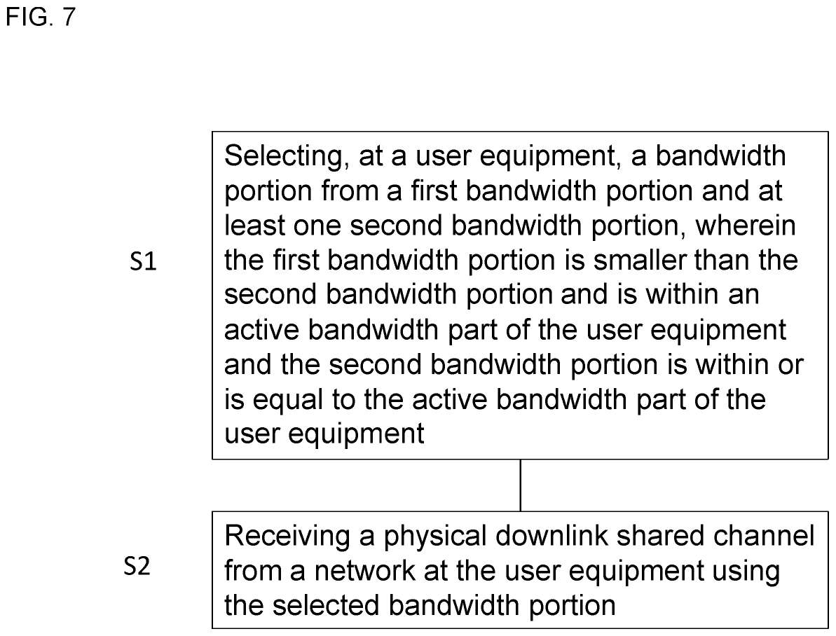

FIG. 7 shows a flowchart of a method according to an example embodiment. The method may be performed at a UE.

In S1, the method comprises selecting, at a user equipment, a bandwidth portion from a first bandwidth portion and at least one second bandwidth portion, wherein the first bandwidth portion is smaller than the second bandwidth portion and the first bandwidth portion and the second bandwidth portion are within an active bandwidth part of a user equipment.

In S2, the method comprises receiving a physical downlink shared channel (PDSCH) from a network at the user equipment using the selected bandwidth portion.

The first and at least one second bandwidth portion are located within the UE's active bandwidth part (BWP). A bandwidth part (BWP) or an active BWP may be the UE's operating bandwidth, a configured operating bandwidth for the UE, a gNB's operating bandwidth or a gNB's system bandwidth.

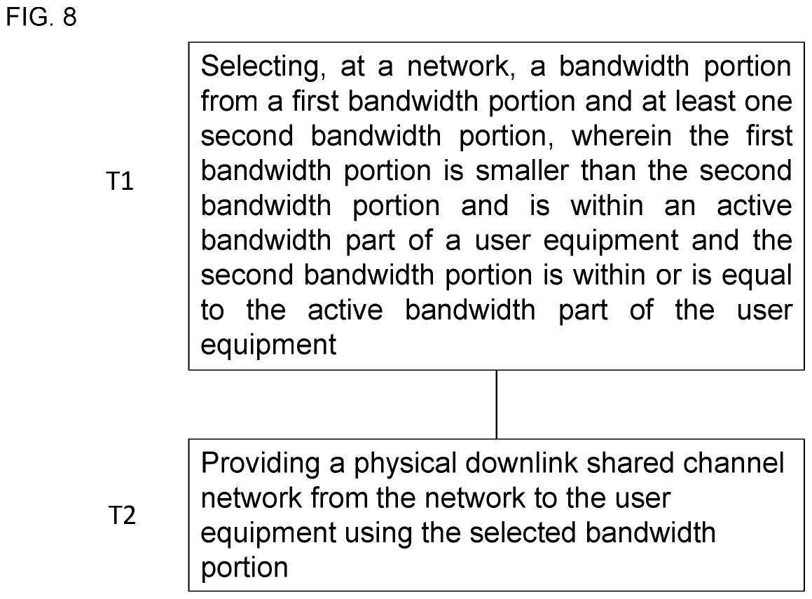

FIG. 8 shows a flowchart of a method according to an example embodiment. The method may be performed at a network node.

In T1, the method comprises selecting, at a network, a bandwidth portion from a first bandwidth portion and at least one second bandwidth portion, wherein the first bandwidth portion is smaller than the second bandwidth portion and the first bandwidth portion and the second bandwidth portion are within an active bandwidth part of a user equipment.

In T2, the method comprises providing a physical downlink shared channel network from the network to the user equipment using the selected bandwidth portion.

Selecting, at a UE and a network, a bandwidth portion from a first bandwidth portion and a second bandwidth portion, wherein the first bandwidth portion is smaller than the second bandwidth portion and receiving, or providing, respectively, a PDSCH using the selected bandwidth portion means that a UE is able to assume a smaller (more narrow) reception bandwidth than an active BWP. As a result, the method may allow wider, active BWPs (which may be used in future networks) while bandwidth portions with smaller (more narrow) reception bandwidths may be selected for reception, thereby reducing UE power consumption.

A method as described with reference to FIG. 7 may comprise receiving a scheduling offset value from the network at the user equipment and selecting the bandwidth portion from the first bandwidth portion and at least one second bandwidth portion based on the scheduling offset value.

A method as described with reference to FIG. 8 may comprise providing a scheduling offset value from the network to the user equipment and selecting the bandwidth portion from the first bandwidth portion and at least one second bandwidth portion based on the scheduling offset value.

The methods may comprise, if the scheduling offset value is less than a threshold value, selecting the first bandwidth portion and receiving or providing, the physical downlink shared channel from the network in the first bandwidth portion. If the scheduling offset value is greater than or equal to the threshold value, the methods may comprise selecting the at least one second bandwidth portion and receiving, or providing, the physical downlink shared channel from the network in the second bandwidth portion. In other words, the reception bandwidth assumption at the UE depends on the applied scheduling offset of the downlink data channel. For example, if the scheduling offset is less than a threshold, the UE can assume a smaller (more narrow) reception bandwidth. The network will schedule the PDSCH using this same bandwidth. The scheduling offset may be associated with a downlink data channel. The scheduling offset value may be defined e.g. as a time between the end of the last symbol carrying PDCCH and the start of the first symbol carrying PDSCH, e.g., k0.

Selecting a bandwidth portion from a first and second bandwidth portion based on a scheduling offset may provide low adaptation latency between different reception bandwidth options or reduce the signalling burden, for example, the RRC signalling or DCI for BWP switching described above.

The threshold value may define at least one of the following: a number of slots or a number of symbols or a time period, e.g., in terms of microseconds (in other words, an absolute time duration e.g. in terms of microseconds). A scheduling offset threshold for the reception bandwidth assumption is defined which can be e.g. number of symbols and/or slots and/or a time period. The scheduling offset threshold is an example of the threshold value.

The method may comprise providing an indication of a threshold value capability from the user equipment to the network. Alternatively, or in addition, the method may comprise receiving an indication of the threshold value from the network at the user equipment. The threshold value indicated by the network may be greater than or equal to the threshold value capability indicated by the user equipment.

In an example embodiment, a scheduling offset threshold is provided by the UE as a UE capability (in other words, a threshold value capability). Alternatively, or in addition, a scheduling offset threshold may be configured by the network and in this case the threshold may be equal or greater than the UE's provided capability. Alternatively, or in addition, a scheduling offset threshold may be a cell specific parameter common to all UEs in the cell.

The network may determine to use a threshold value based on the threshold value capability provided by the UE, or a scheduling offset threshold value configured at the network, which is greater than or equal to the threshold value capability provided by the UE. In the latter case, the network provides the indication of the threshold value to the user equipment.

When the UE receives the indication of the threshold value from the network (the threshold value being greater than or equal to the threshold value capability provided to the network), the UE determines to use the threshold value provided by the network in selecting the bandwidth portion.

At least two reception bandwidth options are defined which are both within the limits of the UE's active bandwidth part. The at least two reception bandwidth options are examples of the first bandwidth portion and the at least one second bandwidth portion.

In an example embodiment, a first reception bandwidth portion is defined for the case where the scheduling offset is less than the above defined scheduling offset threshold. In this example embodiment, the first reception bandwidth portion is smaller than the active BWP size and is smaller than the second reception bandwidth portion.

The size of at least one of the following: the first BW portion, the second BW portion or the active BW part may be configured by the network.

An example method may comprise receiving an indication of the size of the first bandwidth portion from the network. The indication of the size of the first bandwidth portion may further comprise an indication of the size of the active bandwidth part.

The size of the at least one second bandwidth portion may be equal to the size of the active bandwidth part of the user equipment. Alternatively, the size of the at least one second bandwidth portion may be less than the size of an active bandwidth part of the user equipment and the indication of the size of the first bandwidth portion may further comprise an indication of the size of the at least one second bandwidth portion.

The indication of the size of the first BW portion, the second BW portion or the active bandwidth part may be realized via higher layer signalling (such as RRC or MAC).

The UE may provide the network with capability information e.g. about preferable first bandwidth portion size and maximum second bandwidth portion size.

As an example, the network configures the first bandwidth portion size to be equal to or smaller than the preferrable first bandwidth portion size provided by the UE. Preferably, the preferrable first bandwidth portion size provided by the UE is the maximum size which UE can use to achieve power savings. The network may then provide an indication of the configured first bandwidth portion to the UE.

In an example embodiment, a second reception bandwidth portion is defined for the case where the scheduling offset is equal to or greater than the defined scheduling offset threshold. The second reception bandwidth portion may implicitly be the active BWP size or configured as smaller than the active BWP size (e.g., based on the maximum second bandwidth size provided by the UE in capability information as described above) and is larger than the first reception bandwidth portion.

In an example embodiment, the gNB may configure a UE with the BWP size and also the first reception bandwidth portion size and optionally the second reception bandwidth portion size, if different than the BWP size.

When the first bandwidth portion is selected, the method comprises receiving the CORESET in the first bandwidth portion. In an example embodiment, where the first bandwidth portion is the first reception bandwidth option, the CORESET(s) for the PDCCH monitoring are within the first reception bandwidth option. In this case, the transmitted PDSCH is within the first reception bandwidth option

In an example embodiment, when the selected bandwidth portion is the at least one second bandwidth portion (of which the second reception bandwidth option is an example), the transmitted PDSCH is within the second bandwidth portion.

If one or the more of the following conditions apply, the method may comprise selecting the second bandwidth portion and receiving the physical downlink shared channel from the network in the second bandwidth portion: back-to-back scheduling, back-to-back scheduling where reception bandwidth size does not increase in frequency from a previous scheduling, if a gap between the previous scheduling is smaller than T_{gap} or if the time gap between previous scheduling is smaller than T_{gap} and reception bandwidth size does not increase in frequency from the previous scheduling.

In an example embodiment, back-to-back scheduling may be performed without the scheduling offset rule depicted above. In other words, it's possible to support a small scheduling offset (such scheduling offset=0 slots) with a wide BW allocation, provided that the reception BW does not increase, and the gap between consecutive allocations is small enough.

In an example embodiment, the scheduling offset rule does not hold for back-to-back scheduling, provided that the reception BW size in frequency (or BWP size, or allocation) does not increase from the previous scheduling (e.g., the previous PDSCH.

In another example embodiment, the scheduling offset rule does not hold if the time gap (determined e.g. as the time between the end of previous PDSCH scheduling and the start of current PDSCH scheduling) is smaller than T_{gap} (where T_{gap} is a given time period), and the reception BW size in frequency (or BWP size, or allocation) does not increase (compared to previous PDSCH).

In an example embodiment, UE assumes the second bandwidth portion for the reception for, e.g., either the last received DL grant or the last received PDSCH or the last correctly received PDSCH or the last received DCI that triggered CSI-RS measurement and/or reporting.

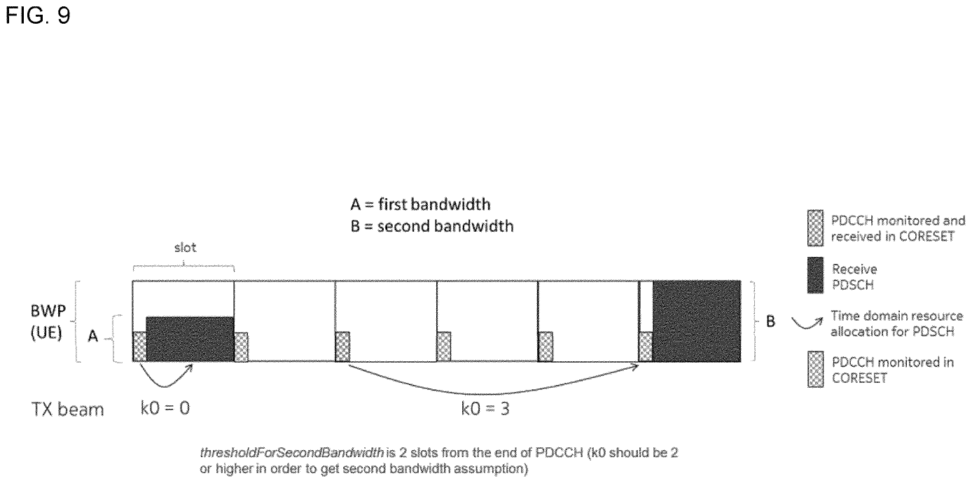

FIG. 9 illustrates examples of both when the scheduling offset is less than the scheduling offset threshold for the reception bandwidth assumption (UE applies the first bandwidth option which is indicated by A) and when the scheduling offset is equal to or greater than the scheduling offset for the reception bandwidth assumption (UE applies the second bandwidth option which is indicated by B). B is equal to the active BWP of the UE and A is smaller than B. In this example, the threshold is 2 slots (i.e., k0 should be 2 or higher in order to use the second bandwidth option) and calculated from the end of the PDCCH (last symbol of the CORESET the PDCCH is transmitted). The x-axis in FIG. 8 presents time domain and γ-axis the frequency domain.

When k0=0, it is less than the scheduling offset threshold and so the first bandwidth option, A, is used. When k0=3, it is greater than the scheduling offset threshold and so the second bandwidth option, B, is used.

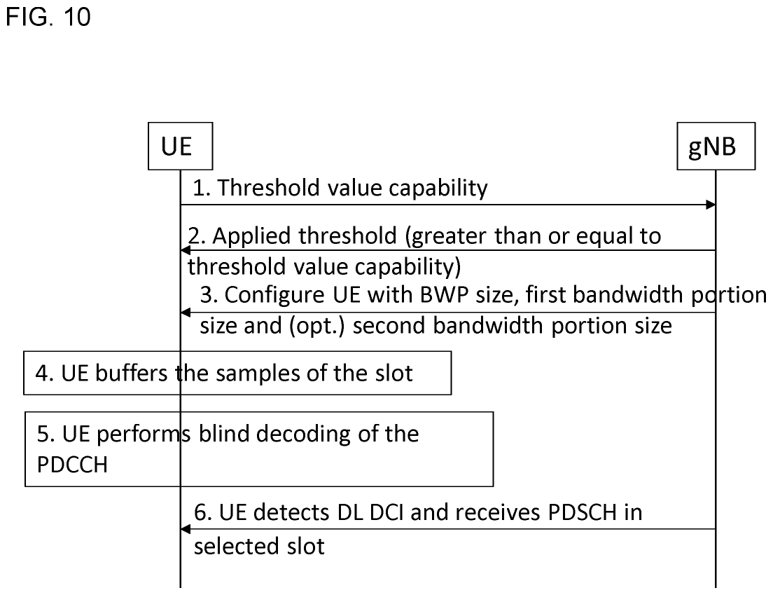

FIG. 10 shows a signalling flow between a UE and a gNB according to an example embodiment.

In step 1, the UE signals threshold for the receive bandwidth assumption as a capability. This is an example of the UE providing an indication of a threshold value capability to the network.

At step 2, the UE's provided threshold may be kept as the defining threshold or the gNB configures the applied threshold which is equal or greater than UE's provided capability. This is an example of an indication of the threshold value from the network at the user equipment, wherein the threshold value is greater than or equal to the threshold value capability.

In step 3, the gNB configures UE with the BWP size and also the first reception bandwidth option (A as illustrated in FIG. 9) and optionally the second reception bandwidth option (B as illustrated in FIG. 9) if different than the BWP size. This is an example of providing an indication of the size of the first bandwidth portion from the network to the user equipment, wherein the indication includes an indication of the size of the active bandwidth part and an indication of the size of the at least one second bandwidth portion if the size of the at least one second bandwidth portion is less than the size of the active bandwidth part of the user equipment

In step 4, UE buffers the samples of the slot assuming the first reception bandwidth if there is no earlier scheduling command (i.e. for data transmission onto this specific slot) with scheduling offset equal to or greater than the threshold set in step 2. If there is an earlier scheduling command (i.e. for data transmission onto this specific slot) with the scheduling offset equal to or greater than the threshold set in step 2, the UE buffers the samples of the slot assuming the second bandwidth portion.

This means that if the UE is not scheduled PDSCH earlier onto this specific slot with the scheduling offset equal to or greater than the threshold (in this case UE would operate with second bandwidth portion in this slot) the UE operates using the first bandwidth portion.

In step 5, the UE performs blind decoding of the PDCCH

In step 6, if the UE detects DL DCI and scheduling of PDSCH with the scheduling offset greater than the threshold set in step 2, the UE marks the slot where to receive PDSCH to be received with the second reception bandwidth. This is an example of the UE selecting the second bandwidth portion based on the scheduling offset. Otherwise if the UE detects DL DCI and scheduling of PDSCH with the scheduling offset less than the threshold set in step 2, the UE receives PDSCH in the slot using the first reception bandwidth option. This is an example of the UE selecting the first bandwidth portion based on the scheduling offset.

Methods as described above with reference to FIGS. 7 to 10 may reduce UE power consumption, provide low adaptation latency between different reception bandwidth options, have a low signalling burden and/or accommodate expected 6G FFT scenarios.

An apparatus may comprise means for selecting, at a user equipment, a bandwidth portion from a first bandwidth portion and at least one second bandwidth portion, wherein the first bandwidth portion is smaller than the second bandwidth portion and is within an active bandwidth part of the user equipment and the second bandwidth portion is within or is equal to the active bandwidth part of the user equipment and means for receiving a physical downlink shared channel from the network at the user equipment using the selected bandwidth portion.

The apparatus may comprise the user equipment, such as a mobile phone, be the user equipment or be comprised in the user equipment or a chipset for performing at least some actions of/for the user equipment.

Alternatively, an apparatus may comprise means for selecting, at a network, a bandwidth portion from a first bandwidth portion and at least one second bandwidth portion, wherein the first bandwidth portion is smaller than the second bandwidth portion and is within an active bandwidth part of a user equipment and the second bandwidth portion is within or is equal to the active bandwidth part of the user equipment and means for providing a physical downlink shared channel network from the network to the user equipment using the selected bandwidth portion.

The apparatus may comprise a network node, be the network node or be comprised in the network node or a chipset for performing at least some actions of/for the network node. The network node may implement a gNB.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 6G networks, similar principles can be applied in relation to other networks and communication systems such as 5G networks or 5G-Advanced networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-28. (canceled)

29. An apparatus comprising: at least one processor; and at least one memory storing instructions that, when executed by the at least one processor, cause the apparatus at least to perform:
selecting a bandwidth portion from a first bandwidth portion and at least one second bandwidth portion, wherein the first bandwidth portion is smaller than the second bandwidth portion and is within an active bandwidth part of the apparatus and the second bandwidth portion is within or equal to the active bandwidth part of the apparatus; and
receiving a physical downlink shared channel from a network at the apparatus using the selected bandwidth portion.

30. The apparatus according to claim 29, wherein the apparatus is further caused to perform: receiving a scheduling offset value from the network at the apparatus and selecting the bandwidth portion from the first bandwidth portion and at least one second bandwidth portion based on the scheduling offset value.

31. The apparatus according to claim 30, wherein the apparatus is further caused to perform: if the scheduling offset value is less than a threshold value, selecting the first bandwidth portion and receiving the physical downlink shared channel from the network in the first bandwidth portion and if the scheduling offset value is greater than or equal to the threshold value, selecting the at least one second bandwidth portion and receiving the physical downlink shared channel from the network in the second bandwidth portion.

32. The apparatus according to claim 31, wherein the threshold value defines at least one of the following: a number of slots, a number of symbols or a time period.

33. The apparatus according to claim 31, wherein the apparatus is further caused to perform: providing an indication of a threshold value capability from the apparatus to the network.

34. The apparatus according to claim 33, wherein the apparatus is further caused to perform: receiving an indication of the threshold value from the network at the apparatus, wherein the threshold value is greater than or equal to the threshold value capability.

35. The apparatus according to claim 29, wherein the apparatus is further caused to perform: selecting the first bandwidth portion and receiving a control resource set in the first bandwidth portion.

36. The apparatus according to claim 29, wherein the apparatus is further caused to perform: selecting the second bandwidth portion and receiving the physical downlink shared channel from the network in the second bandwidth portion, if one or more of the following conditions apply:
back-to-back scheduling, back-to-back scheduling where reception bandwidth size does not increase or decrease in frequency from a previous scheduling, if a gap between the previous scheduling is smaller than T_{gap} or if the time gap between previous scheduling is smaller than T_{gap} and reception bandwidth size does not increase or decrease in frequency from the previous scheduling.

37. The apparatus according to claim 29, wherein the apparatus is further caused to perform: receiving an indication of the size of the first bandwidth portion from the network.

38. The apparatus according to claim 37, wherein the indication of the size of the first bandwidth portion further comprises an indication of the size of the active bandwidth part.

39. The apparatus according to claim 37, wherein the size of the at least one second bandwidth portion is less than the size of the active bandwidth part of the apparatus and the indication of the size of the first bandwidth portion further comprises an indication of the size of the at least one second bandwidth portion.

40. An apparatus comprising: at least one processor; and at least one memory storing instructions that, when executed by the at least one processor, cause the apparatus at least to perform:
selecting a bandwidth portion from a first bandwidth portion and at least one second bandwidth portion, wherein the first bandwidth portion is smaller than the second bandwidth portion and is within an active bandwidth part of a user equipment and the second bandwidth portion is within or equal to the active bandwidth part of the user equipment; and
providing a physical downlink shared channel from the apparatus to the user equipment using the selected bandwidth portion.

41. The apparatus according to claim 40, wherein the apparatus is further caused to perform: providing a scheduling offset value from the apparatus to the user equipment for use in selecting the bandwidth portion at the user equipment and selecting the bandwidth portion from the first bandwidth portion and at least one second bandwidth portion at the apparatus based on the scheduling offset value.

42. The apparatus according to claim 41, wherein the apparatus is further caused to perform: if the scheduling offset value is less than a threshold value, selecting the first bandwidth portion, and if the scheduling offset value is greater than or equal to the threshold value, selecting the at least one second bandwidth portion.

43. The apparatus according to claim 42, wherein the threshold value defines at least one of the following: a number of slots or a number of symbols.

44. The apparatus according to claim 40, wherein the apparatus is further caused to perform: using the first bandwidth portion and providing a control resource set in the first bandwidth portion.

45. The apparatus according to claim 40, wherein the apparatus is further caused to perform: selecting the second bandwidth portion and providing the physical downlink shared channel from the apparatus to the user equipment in the second bandwidth portion, if one or more of the following conditions apply:
back-to-back scheduling, back-to-back scheduling where reception bandwidth size does not increase or decrease in frequency from a previous scheduling, if a gap between the previous scheduling is smaller than T_{gap} or if the time gap between previous scheduling is smaller than T_{gap} and reception bandwidth size does not increase or decrease in frequency from the previous scheduling.

46. The apparatus according to claim 40, wherein the apparatus is further caused to perform: providing an indication of the size of the first bandwidth portion from the apparatus to the user equipment.

47. The apparatus according to claim 40, wherein the size of the at least one second bandwidth portion is less than the size of the active bandwidth part of the user equipment and wherein the indication of the size of the first bandwidth portion further comprises an indication of the size of the at least one second bandwidth.

48. A method comprising:
selecting, at a user equipment, a bandwidth portion from a first bandwidth portion and at least one second bandwidth portion, wherein the first bandwidth portion is smaller than the second bandwidth portion and is within an active bandwidth part of the user equipment and the second bandwidth portion is within or equal to the active bandwidth part of the user equipment; and
receiving a physical downlink shared channel from a network at the user equipment using the selected bandwidth portion.
